(19) United States
(12) Patent Application Publication
(10) Pub. No.: US 2016/0328994 A1
(43) Pub. Date: Nov. 10, 2016

(54) BIOLOGICAL INFORMATION PROCESSING SYSTEM, SERVER SYSTEM, BIOLOGICAL INFORMATION PROCESSING DEVICE, AND BIOLOGICAL INFORMATION PROCESSING METHOD

(71) Applicant: Seiko Epson Corporation, Tokyo (JP)

(72) Inventors: Michihiro Nagaishi, Suwa-shi (JP); Hironori Hasei, Azumino-shi (JP)

(21) Appl. No.: 15/138,047

(22) Filed: Apr. 25, 2016

(30) Foreign Application Priority Data
May 7, 2015 (JP) 2015-094789

(51) Int. Cl. G09B 19/00; A63B 24/00

(52) U.S. Cl. CPC G09B 19/0038; A63B 24/0062

(57) ABSTRACT

A biological information processing system includes: an information acquirer which acquires biological information and motion information of a subject measured by a sensor; a processor which performs processing of estimating psychological state information of the subject, at least on the basis of the biological information; and an exercise advice information outputter which outputs exercise advice information to the subject, at least on the basis of the motion information. The processor specifies an output timing when the exercise advice information is outputted, on the basis of the psychological state information. The exercise advice information outputter outputs the exercise advice information at the output timing that is specified.

### CROSS-REFERENCES TO RELATED APPLICATIONS

This application claims priority to Japanese Patent Application No. 2015-094789, filed May 7, 2015, the entirety of which is herein incorporated by reference.

### BACKGROUND

1. Technical Field

The present invention relates to a biological information processing system, a server system, a biological information processing device, and a biological information processing method or the like.

2. Related Art

The development of motion sensors has enabled detailed measurement of human movements and has thus enabled advice on exercise such as sport to be offered by a machine on the basis of measured movements. By using such a device, a user can practice on his/her own without having a coach or instructor. For example, JP-A-2000-311192 discloses a lifestyle improvement support system as a device which offers advice on user's action.

Even when proper advice to improve an action such as exercise can be presented to the user by a machine, if the user cannot positively accept the advice, the effects of the advice cannot be demonstrated sufficiently. If the user is in a negative mental state, for example, in a stressful state, being insecure, being less motivated, or not being at rest, it is difficult for the user to accept advice no matter how good it is.

JP-A-2000-311192 discloses a lifestyle improvement support system which offers advice suitable for the stress state of the target user, thus making it easier for the target user to accept the advice. However, in the method disclosed in JP-A-2000-311192, preparation is troublesome because personal life information needs to be inputted in advance. Also, this method cannot cope with advice in circumstances where the mental state such as stress constantly changes, such as when the user is playing sport.

### SUMMARY

An advantage of some aspects of the invention is to provide a biological information processing system, a server system, a biological information processing device, and a biological information processing method or the like that enable advice to be offered when a subject is in a state where the subject will easily accept the advice.

An aspect of the invention relates to a biological information processing system including: an information acquirer which acquires biological information and motion information of a subject measured by a sensor; a processor which performs processing of estimating psychological state information of the subject, at least on the basis of the biological information; and an exercise advice information outputter which outputs exercise advice information to the subject, at least on the basis of the motion information. The processor specifies an output timing when the exercise advice information is outputted, on the basis of the psychological state information. The exercise advice information outputter outputs the exercise advice information at the output timing that is specified.

According to the aspect of the invention, the psychological state information of the subject is specified on the basis of the biological information of the subject doing exercise, and the output timing for the exercise advice information is specified on the basis of the specified psychological state information. Also, the exercise advice information is specified on the basis of the motion information of the subject, and the exercise advice information is outputted at the specified output timing. Thus, advice can be offered when the subject is in the state where the subject will easily accept the advice.

In the aspect of the invention, the exercise advice information outputter may output the exercise advice information on the basis of the motion information acquired in a predetermined period before the output timing that is specified.

With this configuration, it is possible to output the exercise advice information based on the motion information that is immediately before the output timing, or the like.

In the aspect of the invention, the processor may estimate motivation information as the psychological state information on the basis of the biological information.

With this configuration, it is possible to specify the output timing for the exercise advice information on the basis of the motivation level of the subject, or the like.

In the aspect of the invention, the processor may specify the output timing on the basis of a timing when a motivation value expressed by the motivation information reaches a predetermined threshold or above.

With this configuration, it is possible to output the exercise advice information at the timing when the motivation of the subject reaches a certain level or above, or the like.

In the aspect of the invention, the processor may specify the output timing on the basis of a timing when the motivation value reaches a predetermined threshold or above and before a timing when the motivation value reaches a maximum.

With this configuration, it is possible to output the exercise advice information at the timing when the motivation of the subject is at a certain level or above and when the motivation is in ascending trends, or the like.

In the aspect of the invention, the processor may specify a first output timing on the basis of a timing when a motivation value expressed by the motivation information reaches a first threshold or above, and may specify a second output timing that is different from the first output timing on the basis of a timing when the motivation value becomes equal to or above a second threshold that is lower than the first threshold. The exercise advice information outputter may output first exercise advice information at the first output timing, and may output second exercise advice information that is different from the first exercise advice information at the second output timing.

With this configuration, it is possible to output the exercise advice information of different contents according to the motivation level of the subject, or the like.

In the aspect of the invention, the second exercise advice information may be information with a smaller amount of information than the first exercise advice information.

With this configuration, it is possible to output the first exercise advice information with a greater amount of information if the motivation of the subject is at a predetermined threshold or above, and to output the second exercise advice information with a smaller amount of information if the motivation of the subject is below the predetermined threshold, or the like.

In the aspect of the invention, the processor may specify the output timing on the basis of the psychological state information and the motion information.

With this configuration, it is possible to output the exercise advice information, for example, at a timing when the subject is having a pause in exercise and when the motivation is at a certain level or above, or the like.

In the aspect of the invention, there may be a first exercise period to a third exercise period when the subject is in an exercising state, and a first non-exercise period and a second non-exercise period when the subject is in a non-exercising state. If the first non-exercise period is a period between the first exercise period and the second exercise period, and the second non-exercise period may be a period which is between the second exercise period and the third exercise period and which is longer than the first non-exercise period, the processor may specify the second non-exercise period on the basis of the motion information and may specify a timing within the second non-exercise period as the output timing.

With this configuration, it is possible to output the exercise advice information, for example, at a timing when the subject is taking a break during exercise, or the like.

In the aspect of the invention, the processor may detect an abnormal movement of the subject on the basis of the motion information and may specify the output timing on the basis of the abnormal movement that is detected.

With this configuration, when an abnormal movement of the subject is detected, it is possible to immediately output the exercise advice information regardless of the motivation of the subject, or the like.

In the aspect of the invention, the exercise advice information outputter may generate the exercise advice information, at least on the basis of the motion information. Next, the processor may specify the output timing, at least on the basis of the biological information. Next, the exercise advice information outputter may output the exercise advice information that is generated, at the output timing that is specified.

With this configuration, it is possible to output the exercise advice information generated in advance, at a timing when the subject will easily accept the information, or the like.

In the aspect of the invention, the processor may estimate motivation information as the psychological state information and may specify the output timing on the basis of a timing when a motivation value expressed by the motivation information reaches a predetermined threshold or above.

With this configuration, it is possible to output the exercise advice information generated in advance, at a timing when the motivation of the subject reaches a certain level or above, or the like.

In the aspect of the invention, the processor may detect an abnormal movement of the subject on the basis of the motion information and may specify the exercise advice information on the basis of the abnormal movement that is detected.

With this configuration, it is possible to generate exercise advice information in advance when an abnormal movement takes place, and to output the exercise advice information generated in advance at a timing when the motivation of the subject is growing, or the like.

Another aspect of the invention relates to a server system including the biological information processing system.

Still another aspect of the invention relates to a biological information processing device including the biological information processing system.

Yet another aspect of the invention relates to a biological information processing method including: acquiring biological information and motion information measured by a sensor; performing processing of estimating psychological state information, at least on the basis of the biological information; specifying an output timing when exercise advice information is outputted, on the basis of the psychological state information; and outputting the exercise advice information at the output timing that is specified, at least on the basis of the motion information.

### BRIEF DESCRIPTION OF THE DRAWINGS

The invention will be described with reference to the accompanying drawings, wherein like numbers reference like elements.

FIG. 1 shows an example of system configuration according to a first embodiment.

FIGS. 2A to 2C are explanatory views showing specific examples of application of the first embodiment.

FIG. 3 is an explanatory view showing biological information and psychological state information.

FIG. 4 is a flowchart for explaining a flow of processing according to the first embodiment.

FIG. 5 is an explanatory view showing an output timing for exercise advice information.

FIG. 6 is another explanatory view showing an output timing for exercise advice information.

FIGS. 7A to 7F are explanatory views showing specific examples of exercise advice information.

FIG. 8 is a flowchart for explaining a flow of processing according to a first modification.

FIG. 9 is a flowchart for explaining a flow of processing according to a second modification.

FIG. 10 is an explanatory view showing each output timing for exercise advice information with different amounts of information.

FIG. 11 shows an example of system configuration according to a second embodiment.

FIG. 12 is an explanatory view showing a specific example of quantified psychological state information.

FIG. 13 is an explanatory view showing exercise intensity and how it can influence motivation.

FIGS. 14A and 14B show a specific example of the configuration of a biological information processing device.

FIG. 15 shows a specific example of the configuration of a biological information processing system.

### DESCRIPTION OF EXEMPLARY EMBODIMENTS

Hereinafter, embodiments will be described. The embodiments described below should not unduly limit the contents of the invention described in the appended claims. Not all the configurations described in the embodiments are necessarily essential components of the invention.

### 1. Outline

As described above, the development of motion sensors has enabled detailed measurement of human movements and has thus enabled advice on exercise such as sport to be offered by a machine on the basis of measured movements. By using such a device, a user can practice on his/her own and improve his/her skills without having a coach or instructor. However, even when proper advice to improve an action such as exercise can be presented to the user by a machine, if the user cannot positively accept the advice, the effects of the advice cannot be demonstrated sufficiently. If the user is in a negative mental state, for example, in a stressful state, being insecure, being less motivated, or not being at rest, it is difficult for the user to accept advice no matter how good it is.

Thus, in the embodiments, biological information of a subject who does exercise is acquired, and psychological state information of the subject is specified on the basis of the acquired biological information. On the basis of the specified psychological state information, an output timing for exercise advice information is specified. For example, a timing when the motivation of the subject reaches a predetermined threshold or above is specified as an output timing. This is because the subject will accept exercise advice more easily when the subject is more motivated than when less motivated, as described above.

The exercise advice information is specified on the basis of motion information of the subject. Then, for example, the exercise advice information is outputted to a display at the specified output timing, and the exercise advice information is displayed on the display.

In this way, according to the embodiments described below, it is possible to offer advice when the subject is in a state where the subject will easily accept the advice. While an example of offering advice on exercise when the subject is doing exercise is described hereinafter, the embodiments are not limited this example.

### 2. First Embodiment

### 2.1 Example of System Configuration

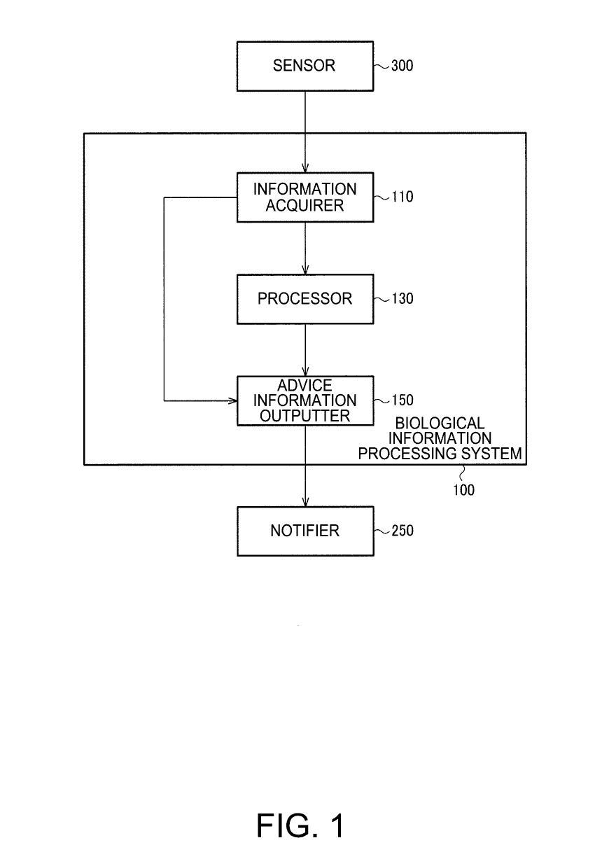

Next, FIG. 1 shows an example of the configuration of a biological information processing system 100 according to this embodiment and a biological information processing device including this system.

The biological information processing system 100 includes an information acquirer 110 which acquires biological information and motion information of a subject measured by a sensor 300, a processor 130 which performs processing of estimating psychological state information of the subject, at least on the basis of the biological information, and an exercise advice information outputter 150 which outputs exercise advice information to the subject, at least on the basis of the motion information. The processor 130 specifies an output timing when the exercise advice information is outputted, on the basis of the psychological state information. The exercise advice information outputter 150 outputs the exercise advice information at the specified output timing. Thus, it is possible to offer advice when the subject is in the state where the subject will easily accept the advice.

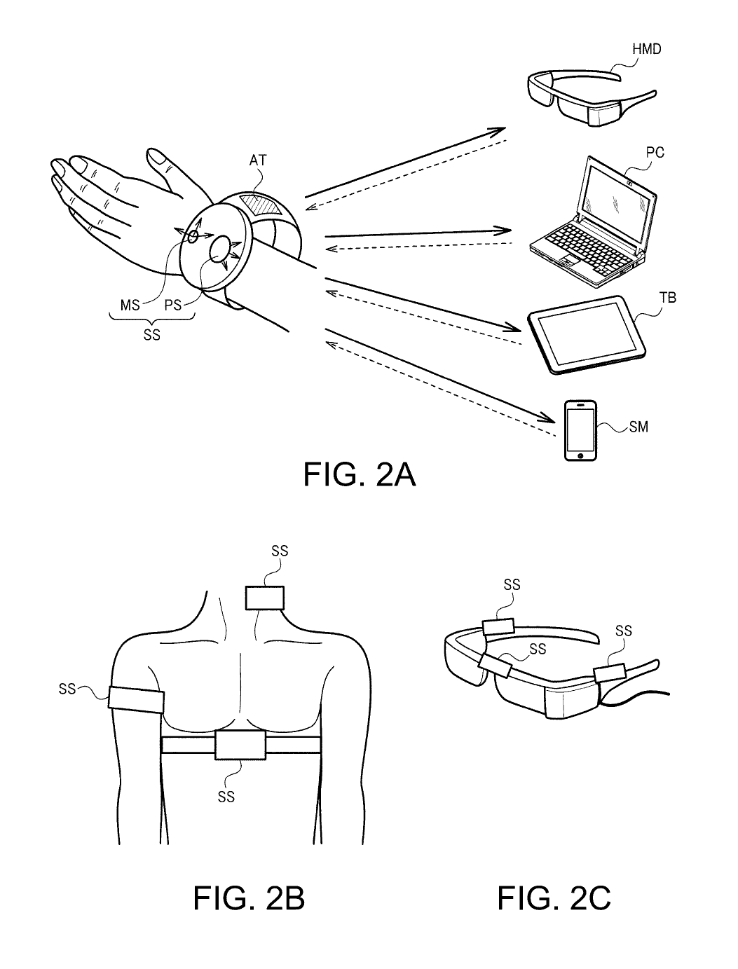

The biological information processing system 100 is installed, for example, in a mobile terminal, sensor device or the like. Specifically, an example of a biological information processing device including the biological information processing system 100 may be a wristband-type (watch-type) wearable information terminal as shown in FIG. 2A, a head-mounted display shown in FIG. 2C described below, or the like. The biological information processing device shown in FIG. 2A includes the biological information processing system 100, a sensor SS including a pulse wave sensor PS and a motion sensor MS, and an antenna (communicator) AT. As shown in FIG. 2A, the biological information processing device is connected for communication with an information processing device such as a head-mounted display HMD, a personal computer PC, a tablet terminal TB, or a smartphone SM. The biological information processing system 100 and the biological information processing device including this system are not limited to the configurations shown in FIG. 1 and FIG. 2A and can be implemented with various modifications such as omitting a part of the components or adding another component. A part or all of the functions of the biological information processing system 100 of the embodiment may be implemented by a server connected via communication with the biological information processing device.

Next, processing performed by each part of the biological information processing system 100 will be described.

The information acquirer 110 acquires biological information and motion information of the subject measured by the sensor 300. If wirelessly connected or wire-connected to the sensor 300, the information acquirer 110 may be a communicator (I/F, antenna or the like) which transmits and receives data.

The sensor 300 includes the pulse wave sensor (biological sensor) PS and the motion sensor MS as shown in FIG. 2A, for example.

The pulse wave sensor PS is a sensor for detecting a pulse wave sensor signal. For example, a photoelectric sensor or the like is conceivable. The pulse wave sensor PS is one of biological sensors, and the biological sensors in the embodiment are not limited to this. When the pulse wave sensor PS is used as a biological sensor, the information acquirer 110 acquires pulse wave information as biological information. When a photoelectric sensor is used as the pulse wave sensor PS, a sensor configured to cut signal components of external light such as sunlight may be used. This can be implemented, for example, by providing a plurality of photodiodes and performing feedback processing or the like with their signals so as to find difference information. The pulse wave sensor PS is not limited to a photoelectric sensor and may be a sensor using ultrasonic waves. In such a case, the pulse wave sensor PS has two piezoelectric elements. One piezoelectric element is excited to transmit ultrasonic waves into a living body, and the other piezoelectric sensor receives the ultrasonic waves reflected by the bloodstream in the living body. Since a frequency change occurs between the transmitted ultrasonic waves and the received ultrasonic waves due to the Doppler effect of the bloodstream, a signal corresponding to the amount of bloodstream can also be acquired in this case and pulsation information can be estimated. Another sensor may also be used as the pulse wave sensor.

The motion sensor MS is an acceleration sensor, for example. In this case, the information acquirer 110 detects an acceleration sensor signal as motion information (body motion information). A three-axis acceleration sensor includes, for example, an element or the like having a resistance value increased or decreased by an external force, and detects an acceleration in an X-axis direction, an acceleration in a Y-axis direction, and an acceleration in a Z-axis direction. Also, the motion sensor MS may be a three-axis gyro sensor which detects an angular velocity about the X-axis, an angular velocity about the Y-axis, and an angular velocity about the Z-axis, combined with the above three-axis acceleration sensor. Moreover, the motion sensor MS is not limited to the acceleration or the gyro sensor, and may be a direction sensor such as a geomagnetic sensor, or the like. The direction sensor measures the direction to which the sensor directs by angles)(0°˜360°). A sensor having functions of the acceleration sensor, the gyro sensor or the direction sensor may be used as the motion sensor MS.

The sensor SS (sensor 300) may be mounted not only on the wrist of the subject as shown in FIG. 2A but also other sites such as the neck, upper arm or chest of the subject as shown in FIG. 2B. Moreover, in the case where the biological information processing device is a head-mounted display, the sensor SS may be provided, for example, on the bridge or the left and right temples, as shown in FIG. 2C. The pulse wave sensor PS and the motion sensor MS may be provided on the same device or may be provided on different devices.

Next, the processor 130 performs processing of estimating psychological state information of the subject, at least on the basis of the biological information. Details of the processing of estimating the psychological state information will be described later. The processor 130 also specifies an output timing when exercise advice information is outputted, on the basis of the estimated psychological state information.

The exercise advice information outputter 150 generates exercise advice information for the subject, for example, at least on the basis of motion information, and outputs the exercise advice information at the output timing specified by the processor 130. For instance, in the example of FIG. 1, the exercise advice information outputter 150 outputs the exercise advice information to a notifier 250.

The output of the exercise advice information refers to, for example, causing the notifier 250 to read the exercise advice information, or writing the exercise advice information into a buffer, not illustrated, in which information to be provided from the notifier 250 is temporarily stored. Also, for example, in the case where the notifier 250 is provided on a device that is different from the device where the biological information processing system 100 is installed, the output of the exercise advice information refers to transmitting the exercise advice information to the notifier 250 via a network, or the like.

If the notifier 250 is a display, the exercise advice information is display image information. Meanwhile, if the notifier 250 is an audio outputter, the exercise advice information is audio information. However, the embodiment is not limited to these examples. The functions of the processor 130 and the exercise advice information outputter 150 can be implemented by hardware such as various processors (CPU, GPU or the like) and ASIC (gate array or the like), or by a program or the like.

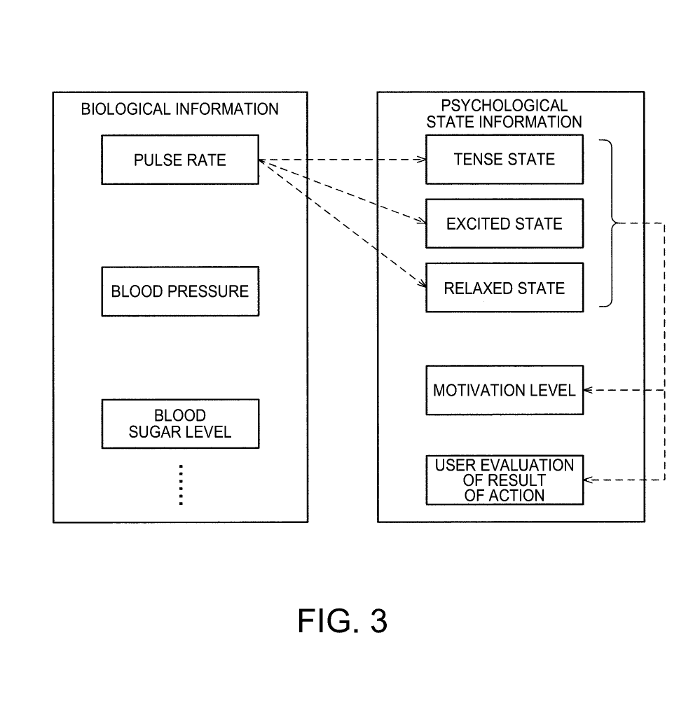

The biological information is information such as pulse rate (heart rate), blood pressure, blood sugar level, blood vessel diameter, body temperature, amount of perspiration, body weight, height, blood type, age, hours of sleep, duration of continuous activity (duration of continuous non-sleep), change in voice characteristics, body shape, way of walking, way of running, way of making a predetermined movement, and DNA, as illustrated in FIG. 3.

The psychological state information includes the tense state, the excited state, the relaxed state, the motivation level (motivation information, described later), and the user evaluation of the result of an action, or various emotions, expressed in the form of numerical values.

The motion information is, for example, the acceleration signal, the angular velocity signal and the direction signal obtained from the motion sensor mounted on the subject's body, or information indicating a motion of the subject specified on the basis of these signal, or the like. However, in the embodiment, the biological information, the psychological state information and the motion information are not limited to these examples. Further details of the processing of estimating the psychological state information will be described later.

### 2.2 Details of Processing

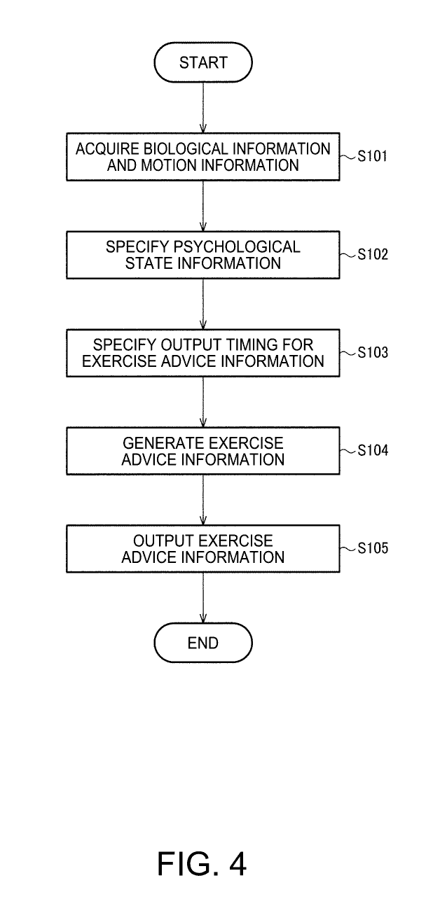

Next, the flow of processing in the embodiment will be described with reference to the flowchart of FIG. 4. First, the information acquirer 110 acquires, for example, biological information and motion information of a subject during exercise, from the sensor 300 (S101). Next, the processor 130 specifies psychological state information on the basis of the acquired biological information (S102). The processor 130 also specifies an output timing for exercise advice information on the basis of the specified psychological state information (S103). Then, the exercise advice information outputter 150 generates exercise advice information on the basis of the motion information (S104) and outputs the generated exercise advice information to the notifier 250 (S105).

Next, the processing in each step of the flowchart of FIG. 4 will be described in detail.

In Step S102, the processor 130 estimates motivation information as the psychological state information on the basis of the biological information.

The motivation information is, for example, information indicating the motivation level of the subject about the current action (exercise), or the like. A highly motivation state is the state where the subject is highly motivated towards the current action (exercise) and is willing to take the action positively. Meanwhile, a less motivated state is the state where the subject is less motivated toward the current action (exercise) and is reluctant to take the action positively. When the subject is in the highly motivated state, the subject often accepts the presented advice more easily.

Thus, it is possible to specify the output timing for the exercise advice information on the basis of the motivation level of the subject, or the like, as described below.

In Step S103, the processor 130 specifies the output timing on the basis of a timing when a motivation value expressed by the motivation information reaches a predetermined threshold or above.

Here, the motivation value is, for example, a parameter found by converting the user's motivation into a numerical value, or the like. For example, as the motivation of the subject increases, the motivation value increases as well. As the motivation of the subject decreases, the motivation value decreases as well.

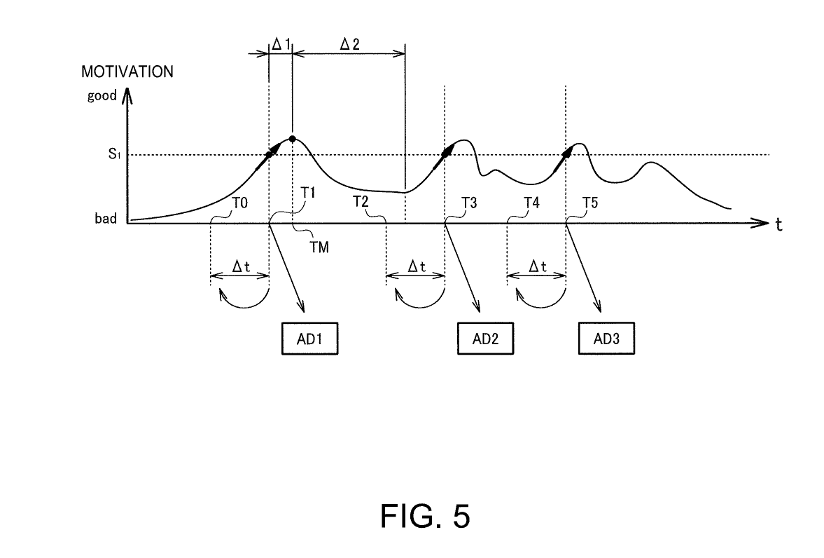

A specific example is shown in the graph of FIG. 5. In the graph of FIG. 5, the horizontal axis represents time and the vertical axis represents motivation level (motivation value). The motivation becomes higher (the motivation value increases) as it goes up in the graph, whereas the motivation becomes lower (the motivation value decreases) as it goes down in the graph. In the example of FIG. 5, individual timings (T1, T3, T5) when the motivation value reaches a predetermined threshold S₁ or above are specified as output timings for respective pieces of advice information (AD1 to AD3).

Here, an output timing may be, for example, the timing when the exercise advice information is outputted to the notifier 250, or the timing when the notifier 250 notifies the user of the exercise advice information. Also, an output timing need not necessarily be the same as the timing when the motivation value reaches the predetermined threshold or above. For example, an output timing may be the timing when a predetermined waiting time has passed since the timing when the motivation value reaches the predetermined threshold or above.

Meanwhile, it is also conceivable that, in contrast to the example of FIG. 5, a smaller motivation value indicates higher motivation, whereas a greater motivation value indicates lower motivation. In this case, the processing of specifying the output timing is equivalent to specifying the output timing on the basis of a timing when the motivation value reaches a predetermined threshold or below. The embodiment includes such modifications.

Thus, it is possible to output the exercise advice information at the timing when the motivation of the subject reaches a certain level or above, or the like.

Also, as shown in FIG. 5, in a period Δ1 before a timing TM when the motivation value reaches a maximum, the motivation of the subject is in ascending trends. However, in a period 42 after the timing TM when the motivation value reaches the maximum, the motivation of the subject is in descending trends. When the motivation is in descending trends, the subject is in the state where subject will not easily accept the advice.

Thus, in the embodiment, in Step S103, the processor 130 specifies the output timing on the basis of the timing when the motivation value reaches the predetermined threshold S₁ or above and before the timing TM when the motivation value reaches the maximum. Specifically, the output timing is specified within the period Δ1 from the timing T1 when the motivation value reaches the predetermined threshold S₁ or above to the timing TM when the motivation value reaches the maximum.

Thus, it is possible to output the exercise advice information at the timing when the motivation of the subject is at a certain level or above and the motivation is in ascending trends, or the like.

Also, the processor 130 may specify the output timing on the basis of the psychological state information and the motion information.

For example, the situation where a subject is practicing golf in a golf practicing range will be described as a specific example. Normally, when practicing golf, a player (subject) continues hitting several balls and then takes a break when the subject is beginning to feel tired. Then, the player resumes practicing after the break. In this case, if exercise advice information is presented during the break rather than when the player is continuously hitting balls, the player will see or listen to the advice more easily. Therefore, in the embodiment, for example, the period when the player is taking a break may be specified on the basis of the motion information, and the output timing may be specified within that period.

Thus, it is possible to output the exercise advice information, for example, at the timing when the subject is having a pause in exercise and when the motivation is at a certain level or above, or the like.

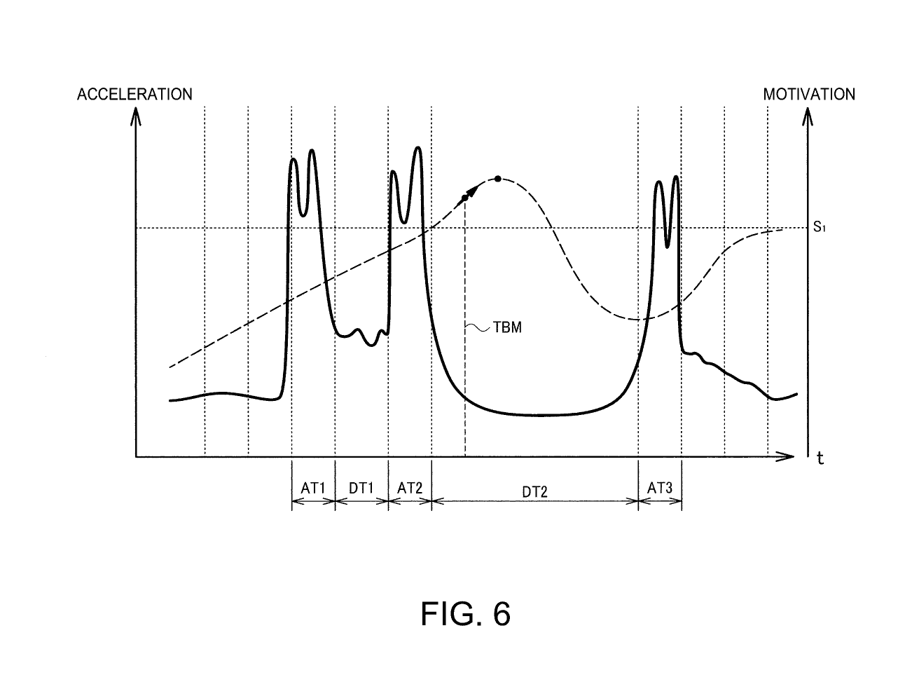

The above description is expressed in a different way with reference to the graph of FIG. 6. In the graph of FIG. 6, the horizontal axis represents time, and the vertical axis on the left-hand side and the solid line represent acceleration, whereas the vertical axis on the right-hand side and the dashed line represent motivation value.

As shown in FIG. 6, it is assumed, for example, that there is a first exercise period AT1 to a third exercise period AT3 during which the subject is in an exercising state, and a first non-exercise period DT1 and a second non-exercise period DT2 during which the subject is in a non-exercising state. The exercise periods are, for example, periods when the player is swinging. The first non-exercise period DT1 is the period between the first exercise period AT1 and the second exercise period AT2, and in the above example, the period between swings. The second non-exercise period DT2 is the period between the second exercise period AT2 and the third exercise period AT3 and which is longer than the first non-exercise period DT1. The second non-exercise period DT2 is, for example, the period when the player is taking a break.

In this case, the processor 130 specifies the second non-exercise period DT2 on the basis of the motion information and specifies a timing within the second non-exercise period DT2 as the output timing. For example, the processor 130 specifies a timing TBM which is within the second non-exercise period DT2 and when the motivation value is the predetermined threshold S₁ or above and before the motivation value reaches the maximum, as the output timing.

Here, the exercise refers to sport, training or the like. The training includes a movement which is normally made in everyday life such as walking or holding a thing if it is made for the purpose of mental and physical toughening, improvement in exercise skills, or the like. The state where the subject is doing exercise is the exercising state, and the period when the subject is in the exercising state is called the exercise period. Similarly, the state where the subject is not doing exercise is the non-exercising state, and the period when the subject is in the non-exercising state is called the non-exercise period.

Thus, it is possible to output the exercise advice information, for example, at the timing when the subject is taking a break during exercise, or the like.

There are also cases where it is better to immediately output the exercise advice information because the subject has made an abnormal movement during exercise.

Here, the abnormal movement is, for example, a movement that is far from an ideal movement for sport or training, or the like. For example, the abnormal movement is a movement that is highly likely to lead to injury, or the like.

In such a case, the processor 130 detects the abnormal movement of the subject on the basis of the motion information and specifies the output timing on the basis of the detected abnormal movement.

Thus, when the abnormal movement of the subject is detected, it is possible to immediately output the exercise advice information regardless of the motivation of the subject, or the like. As a result, it is possible to prevent the subject from getting injured, or the like.

Next, details of Step S104 will be described. In Step S104, the exercise advice information outputter 150 outputs the exercise advice information on the basis of the motion information acquired during a predetermined period before the specified output timing.

For instance, in the example of FIG. 5, the exercise advice information outputter 150 generates and outputs each piece of exercise advice information on the basis of the motion information acquired during a period At before each output timing (AD1 to AD3) for the exercise advice information.

Thus, it is possible to output the exercise advice information based on the motion information immediately before the output timing, or the like.

In the case where the notifier 250 is a display, for example, the exercise advice information is display image information or text information. In the case where the notifier 250 is an audio outputter, for example, the exercise advice information is audio information. In the case where the notifier 250 is a light emitter, for example, the exercise advice information may be light emission information. In the case where the notifier 250 is a vibrator, for example, the exercise advice information may be vibration information. The light emission information is, for example, information indicating a light emitting pattern in which the light emitter 250 is made to emit light, a duration of light emission, or the like. Similarly, the vibration information is, for example, information indicating a vibration pattern in which the vibrator is made to vibrate, a duration of vibration, or the like.

The exercise advice information may be the very information used when the notifier 250 gives a notification, for example, the above display image information, text information and audio information or the like. However, the exercise advice information may also be information indicating a content of advice for exercise. In other words, the exercise advice information may be instruction information to improve a movement when the subject is exercising, or may be display image information showing the instruction information in the form of an image, or audio information giving the instruction information in the form of a sound. The instruction information to improve a movement when the subject is exercising is information giving an instruction to correct the movement or posture of the subject, such as “Speed up your arm swing by 10%” or “Move your feet 10 cm closer”, for example.

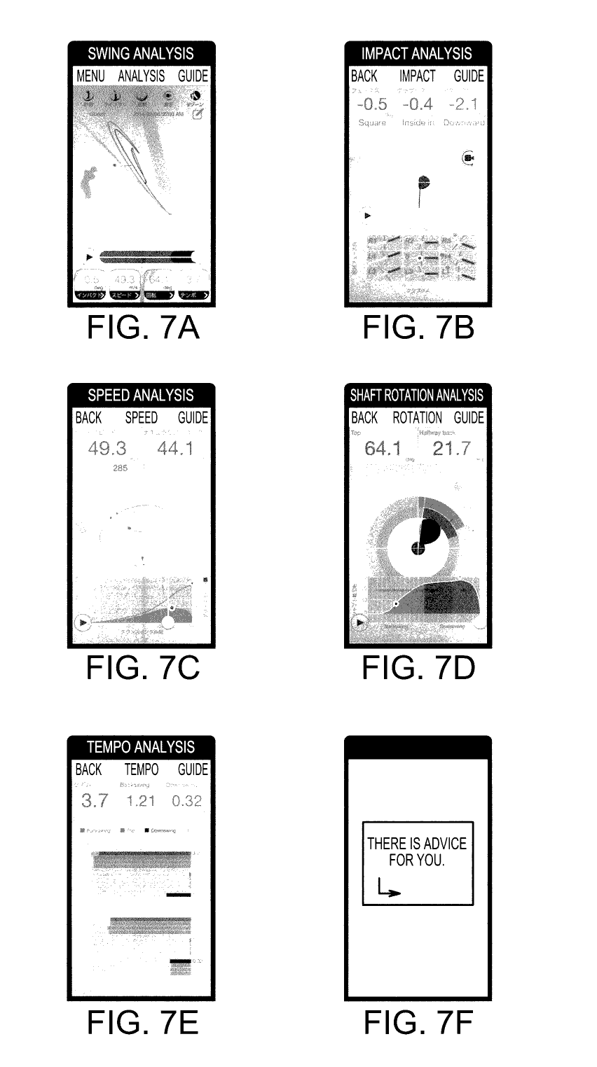

FIGS. 7A to 7E show specific examples in the case where the exercise advice information to be outputted is display image information. FIGS. 7A to 7E are examples of the exercise advice information displayed on the display when the subject is practicing golf. For example, the exercise advice information in FIG. 7A is screen information which compares a V-zone formed when the subject swings, with an ideal V-zone. The exercise advice information in FIG. 7B is screen information which analyzes in detail how the impact is made. The exercise advice information in FIG. 7C is screen information which analyzes the swing speed in detail. The exercise advice information in FIG. 7D is screen information which analyzes the rotation angle of the shaft in detail. The exercise advice information in FIG. 7E is screen information which analyzes the swing tempo in detail. However, the exercise advice information in the embodiment is not limited to these examples.

As described above, according to the embodiment, since there is no need to input personal life information or the like in advance, no time and effort for input is needed. Moreover, this technique is suitable for giving advice in an environment where the user's mental state such as stress constantly changes, such as when the user is playing sport.

### 2.3 First Modification

Next, a first modification will be described. In the above embodiment, exercise advice information is generated after an output timing for the exercise advice information is specified. However, the flow of this processing may be in the reverse order.

That is, in this modification, the exercise advice information outputter 150 generates exercise advice information, at least on the basis of motion information, and then the processor 130 specifies an output timing, at least on the basis of biological information. After that, the exercise advice information outputter 150 outputs the generated exercise advice information at the specified output timing.

Thus, it is possible to output the exercise advice information generated in advance, at the timing when the subject will easily accept the advice, or the like.

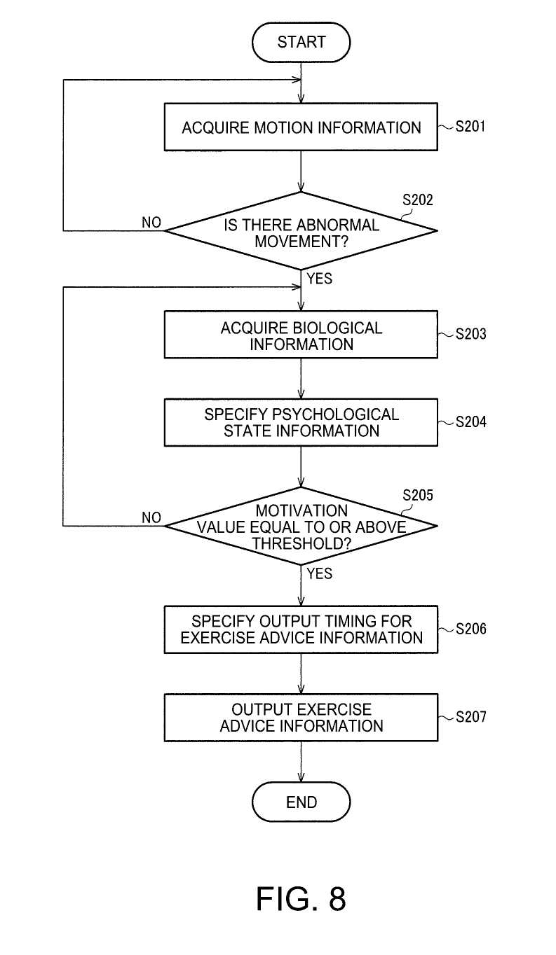

Next, the flow of processing according to the first modification will be described with reference to the flowchart of FIG. 8. In the first modification, first, the information acquirer 110 acquires motion information of a subject during exercise, from the sensor 300 (S201).

Next, the processor 130 determines whether there is an abnormal movement or not, on the basis of the acquired motion information (S202). If it is determined that there is no abnormal movement, the flow goes back to the processing of Step S201.

Meanwhile, if it is determined that there is an abnormal movement, the information acquirer 110 acquires biological information from the sensor 300 (S203). Then, the processor 130 specifies psychological state information on the basis of the acquired biological information (S204). Specifically, the processor 130 specifies motivation information as the psychological state information, as described above.

Subsequently, the processor 130 determines whether the motivation value is a predetermined threshold or above, or not, on the basis of the motivation information (S205). If it is determined that the motivation value is below the predetermined threshold, the flow goes back to S203.

Meanwhile, if it is determined that the motivation value is the predetermined threshold or above, the processor 130 specifies an output timing for exercise advice information (S206).

Then, the exercise advice information outputter 150 generates exercise advice information on the basis of the motion information and outputs the generated exercise advice information to the notifier 250 (S207).

In this way, also in the first modification, the processor 130 estimates the motivation information as the psychological state information and specifies the output timing on the basis of the timing when the motivation value expressed by the motivation information reaches the predetermined threshold or above.

Thus, it is possible to output the exercise advice information generated in advance, at the timing when the motivation of the subject reaches a certain level or above (the motivation value reaches a predetermined threshold or above) or the like.

Also, in the first modification, the processor 130 detects an abnormal movement of the subject on the basis of the motion information and specifies exercise advice information on the basis of the detected abnormal movement.

Thus, it is possible to generate the exercise advice information in advance when an abnormal movement takes place, and to output the exercise advice information generated in advance at the timing when the motivation of the subject is growing, or the like. As described above, if the abnormal movement is a movement that is highly likely to be linked to lead to injury, or the like, the exercise advice information needs to be presented immediately. Therefore, in this case, the predetermined threshold to be compared with the motivation value may be set to a smaller value according to the degree of urgency of the exercise advice information.

### 2.4 Second Modification

Next, a second modification will be described. In the second modification, exercise advice information with different degrees of detail is outputted according to the motivation of the subject. For example, when the subject is less motivated, since the subject will not easily accept advice, exercise advice information notifying the subject of only the presence of advice is outputted. Meanwhile, when the subject is highly motivated, since the subject will easily accept advice, exercise advice information to communicate a specific advice content in detail is outputted.

That is, in the second modification, the processor 130 specifies a first output timing on the basis of a timing when the motivation value expressed by the motivation information reaches a first threshold or above, and specifies a second output timing that is different from the first output timing on the basis of a timing when the motivation information becomes equal to or above a second threshold that is lower than the first threshold. The exercise advice information outputter 150 outputs first exercise advice information at the first output timing and outputs second exercise advice information that is different from the first exercise advice information at the second output timing.

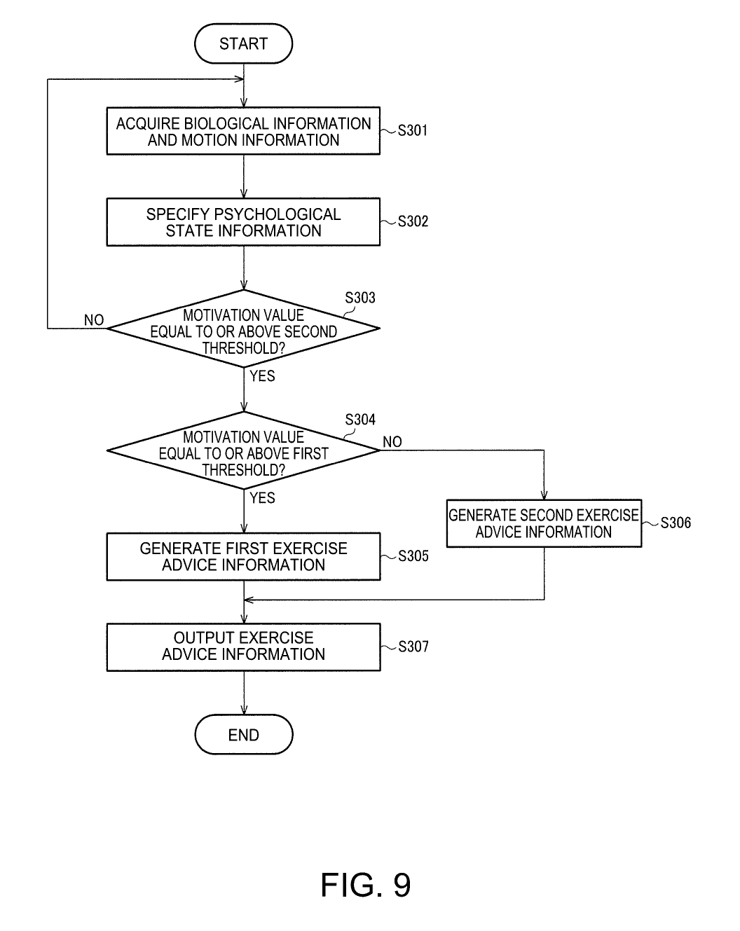

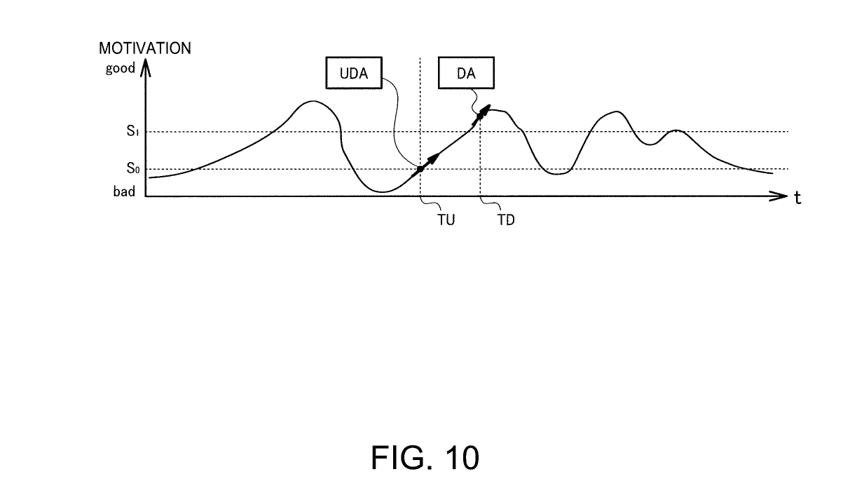

Here, a specific example will be described with reference to the flowchart of FIG. 9 and the graph of FIG. 10.

First, the information acquirer 110 acquires, for example, biological information and motion information of a subject during exercise from the sensor 300 (S301). Next, the processor 130 specifies psychological state information on the basis of the acquired biological information (S302). Here, similarly to the foregoing example, the processor 130 specifies motivation information as the psychological state information.

The processor 130 then determines whether the motivation value expressed by the specified motivation information is equal to or above the second threshold, or not (S303). In the example of FIG. 10, the second threshold is S₀ and lower than the first threshold S₁. If the motivation value is determined as below the second threshold S₀, the flow goes back to the processing of Step S301.

Meanwhile, if the motivation value is determined as equal to or above the second threshold S₀, the processor 130 determines whether the motivation value is equal to or above the first threshold S₁, or not (S304).

If the motivation value is determined as equal to or above the first threshold S₁, it is determined that the subject is motivated enough to accept exercise advice information including a detailed content. Therefore, the first exercise advice information is generated (S305) and the generated first exercise advice information is outputted (S307). For instance, in the example of FIG. 10, a timing TD when the motivation of the subject is equal to or above the first threshold S₁ is specified as the first output timing, and first exercise advice information DA is outputted at this timing.

Here, the first exercise advice information is exercise advice information to communicate a specific advice content in detail, and for example, screen information as shown in FIGS. 7A to 7E described above, or the like.

Meanwhile, if the motivation value is determined as below the first threshold S₁, it is determined that the subject is not motivated enough to accept exercise advice information including a detailed content. Therefore, the second exercise advice information is generated (S306) and the generated second exercise advice information is outputted (S307). For instance, in the example of FIG. 10, a timing TU when the motivation of the subject is equal to or above the second threshold So and below the first threshold Si is specified as the second output timing, and second exercise advice information UDA is outputted at this timing.

Here, the second exercise advice information is information with a smaller amount of information than the first exercise advice information, and for example, screen information to communicate only the presence of advice to the subject as shown in FIG. 7F, or the like.

Thus, it is possible to output the exercise advice information with different contents according to the motivation level of the subject, or the like.

Specifically, as in the foregoing example, it is possible to output the first exercise advice information with a greater amount of information if the motivation of the subject is a predetermined threshold or above, and to output the second exercise advice information with a smaller amount of information if the motivation of the subject is below the predetermined threshold, or the like.

### 3. Second Embodiment

Next, a second embodiment will be described. In the first embodiment, the biological information processing device outputs the exercise advice information. However, in this embodiment, at least motion information of a subject is transmitted to a server system, and the server system performs processing of specifying exercise advice information and outputs the specified exercise advice information to another information processing device.

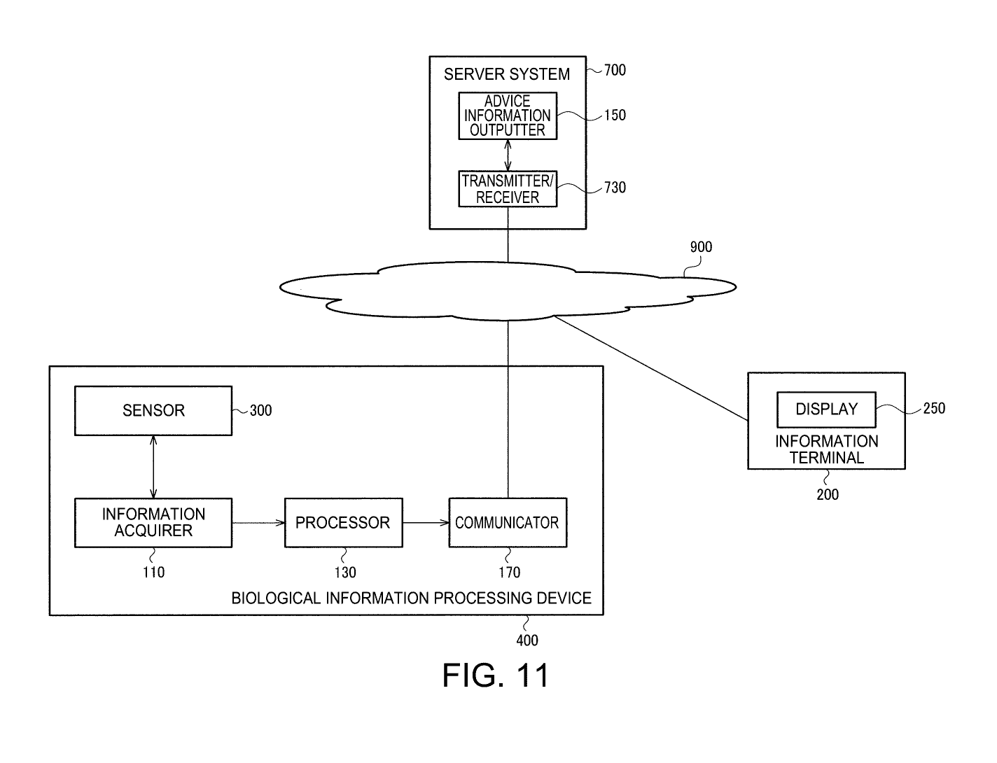

Specifically, FIG. 11 shows an example of the system configuration according to this embodiment. A biological information processing device 400 includes a sensor 300, an information acquirer 110, a processor 130, and a communicator 170 which transmits at least motion information of a subject to a server system 700. The server system 700 includes a transmitter/receiver 730 which communicates with the biological information processing device 400 and an information terminal 200 operated by a user, and an exercise advice information outputter 150. That is, in the second embodiment, the biological information processing system 100 is implemented in a distributive manner by the biological information processing device 400 and the server system 700. The biological information processing device 400, the server system 700 and the information terminal 200 are connected for communication with each other via a network 900.

Next, a specific flow of processing will be described. First, the information acquirer 110 of the biological information processing device 400 acquires biological information and motion information of a subject from the sensor 300. The processor 130 then specifies psychological state information of the subject on the basis of the biological information and specifies an output timing for exercise advice information on the basis of the psychological state information. The communicator 170 transmits the motion information and information about the specified output timing to the transmitter/receiver 730 of the server system 700.

Then, the exercise advice information outputter 150 of the server system 700 generates exercise advice information on the basis of the received motivation information and outputs the generated exercise advice information to the received output timing. The outputted exercise advice information is transmitted from the transmitter/receiver 730 to the information terminal 200, and a display 250 of the information terminal 200 displays the exercise advice information.

Also, various modifications of this embodiment are conceivable. For example, in the case where the server system 700 has a processor, not shown, the communicator 170 may transmit the biological information and the motion information to the transmitter/receiver 730, without causing the processor 130 of the biological information processing device 400 to perform processing of specifying psychological state information or processing of specifying an output timing for exercise advice information. In this case, the processor of the server system 700 may perform processing of specifying psychological state information on the basis of the biological information and then specifying an output timing.

Thus, the biological information processing device 400 need not perform processing of generating exercise advice information, and it is possible to reduce the amount of processing by the biological information processing device 400, or the like.

The server system 700 is made up of a plurality of server devices such as a processing server and data server, for example. However, the specific configurations of the server system 700, the biological information processing device 400 and the information terminal 200 are not limited to these examples and can be implemented with various modifications such as omitting a part of the components or adding another component. Also, a part of the functions of the server system 700 may be implemented in a distributive manner by the biological information processing device 400 and the information terminal 200 or the like.

In the example of FIG. 11, the biological information processing device 400, the information terminal 200 and the server system 700 are connected for communication via the network 900 including at least one of wired and wireless connections. The network 900 may include various networks with different communication standards. For example, the biological information processing device 400 and the information terminal 200 are connected to each other via Bluetooth (trademark registered), wireless LAN or the like, and the information terminal 200 and the server system 700 are connected to each other via the internet. However, the embodiment is not limited to this example.

### 4. Processing of Estimating Psychological State

Next, processing of estimating psychological state information will be described in detail. Particularly, a specific method for estimating an introspective state such as motivation level or user evaluation about an action, from among the psychological state information, on the basis of a mental state such as being tense, being relaxed, or being awake, will be described. The user evaluation about an action refers to, for example, information indicating a degree to which the user, having taken an action, is pleased with what he or she has done or regrets taking that action. This user evaluation may be what the user consciously feels, or may be what the user unconsciously feels.

First, the mental state such as being tense, being relaxed, or being awake is estimated on the basis of the biological information such as heart rate (pulse rate), blood pressure, and body temperature. Here, an estimation method based on heart rate (pulse rate) is described. The heart rate (heartbeat) indicates the active state of the heart. Since the heart is influenced by sympathetic nerves, the active state of the sympathetic nerves can be estimated on the basis of the state of the heart rate.

As a method for analyzing the influence of sympathetic nerves and parasympathetic nerves on heart rate, frequency analysis is commonly used. Frequency analysis (FFT) is performed on temporal changes in the distance between peaks (R-R interval) in a graph showing changes in the heart rate, and low-frequency components LF and high-frequency components HF are separated and analyzed.

On the basis of the low-frequency components LF and the high-frequency components HF, the influence of sympathetic nerves and parasympathetic nerves can be quantified. The quantified value corresponds to the degree of mental stress. Based on the magnitude of this numerical value, the mental state of being relaxed, tense, or pleased or the like can be estimated.

The quantified mental state such as being tense does not necessarily coincides with the psychological state of, for example, being moved by watching TV (highly motivated) or being pleased (user evaluation). Often, even when the numerical value indicates the state of being excited or relaxed, it cannot necessarily be determined with a single mental state indicator alone that the user is in a comfortable state. Therefore, it is considered necessary to make a comprehensive determination based on the user's circumstance at the time, including the possibility of other mental states.

Next, a method for estimating a psychological state such as user evaluation of the result of an action and motivation level on the basis of a plurality of quantified mental states will be described.

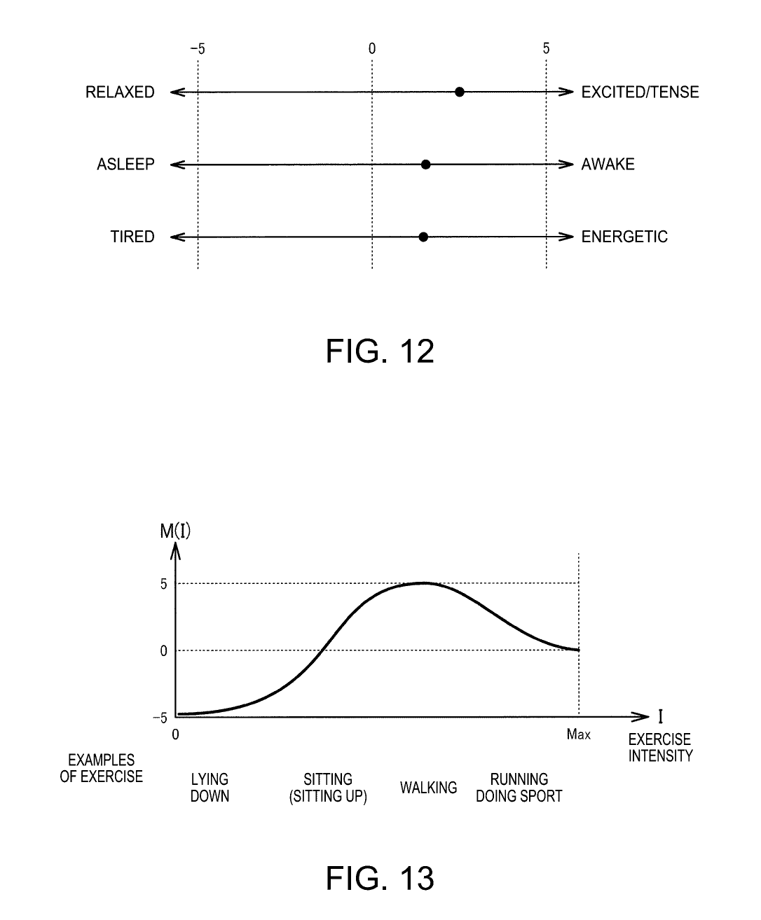

First, on the basis of the heart rate (HR), which is one item of biological information, a plurality of mental states are expressed in the form of numerical values by frequency analysis of the heart rate, or the like. Here, an example where three indicators of A: relaxed—excited/tense, B: asleep—awake, and C: tired—energetic (degree of physical strength) shown in FIG. 12 is described. Specifically, A uses the proportion of HF and LF. B uses HR at rest (base HR). C uses the state where HR is at a maximum value (if the most recent maximum value is relatively low, it is presumed that the user is tired physically and psychologically), and the like.

Each of the indicators A, B and C includes the opposite states. For example, in the case of A, where the neutral point between being relaxed and being excited is 0, the maximum value of being relaxed is −5 and the maximum value of being excited is 5. The same applies to B and C.

Next, in estimating the psychological state, not only the plurality of mental states but also the exercising state of the person is taken into account. Even in the same mental state, as exercise intensity rises, the influence of the mental state on the heart rate decreases. Therefore, the influence of exercise intensity is expressed by a function M(I) as shown in FIG. 13 and used for the estimation of the psychological state. The horizontal axis in FIG. 13 represents exercise intensity I (Mets or the like) and the vertical axis represents exercising state M(I), which is a function of I. In less physically active states such as lying down, sitting, or sitting up, M(I) is lower than in other exercising states. M(I) is at its maximum in a walking state. When exercise intensity equivalent to running or doing sport is obtained, M(I) is smaller than in walking. In the example of FIG. 13, the range of M(I) is from −5 to 5, corresponding to the example of FIG. 12.

On the basis of the mental state and the exercising state thus found, psychological state X is quantified by the following equation, where α, β and γ are variable and can be adjusted according to need.

X=(αA+62 B+γC+ . . . )+M(I) (1)

In the example of FIG. 12, A=3 and B=C=2 hold. Now it is assumed that all of α, β and γ are 1 and that the user is sitting. In the sitting state, M(I)=0 holds, resulting in X=7. That is, the motivation level can be specified as 7.

When the motivation level is high, the user is often excited. However, when the body is half asleep or less energetic, there is a possibility that the user is in an excited state simply due to a certain stimulation. In such a case, it cannot be said that the user is motivated enough. Meanwhile, during exercise, the pulse rate rises because of the exercise and it is considered that the influence of being motivated decreases. Therefore, the influence of the exercise needs to be discounted. By thus taking the plurality of mental states and exercise into consideration, the amount of motivation can be estimated more accurately.

As described above, the psychological state can be quantified on the basis of the mental state based on heart rate, and the exercising state based on movement. Similarly, in the case of blood pressure and body temperature other than heart rate, A, B and C are found by estimating other items of biological information. In the case of using a plurality items of biological information, for example, A, B and C are found on the basis of heart rate, and A′, B′ and C′ are found on the basis of blood pressure. Then, the psychological state is found by linearly combining these.

In this way, the processor 130 in this embodiment estimates the motivation level of the user as the psychological state information. The motivation level may be estimated directly from biological information or may be estimated from the tense state or the like.

### 5. Example of Configuration of Biological Information Processing Device

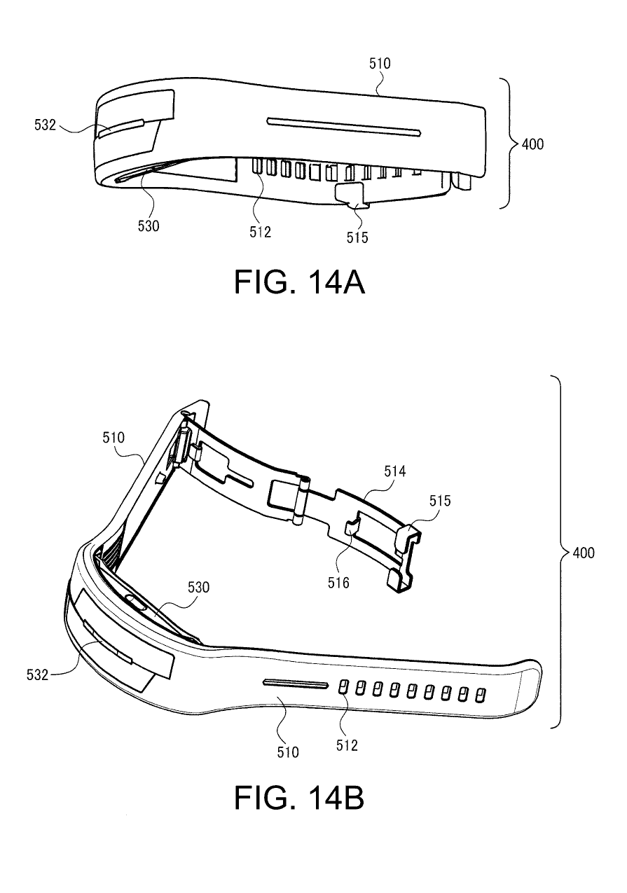

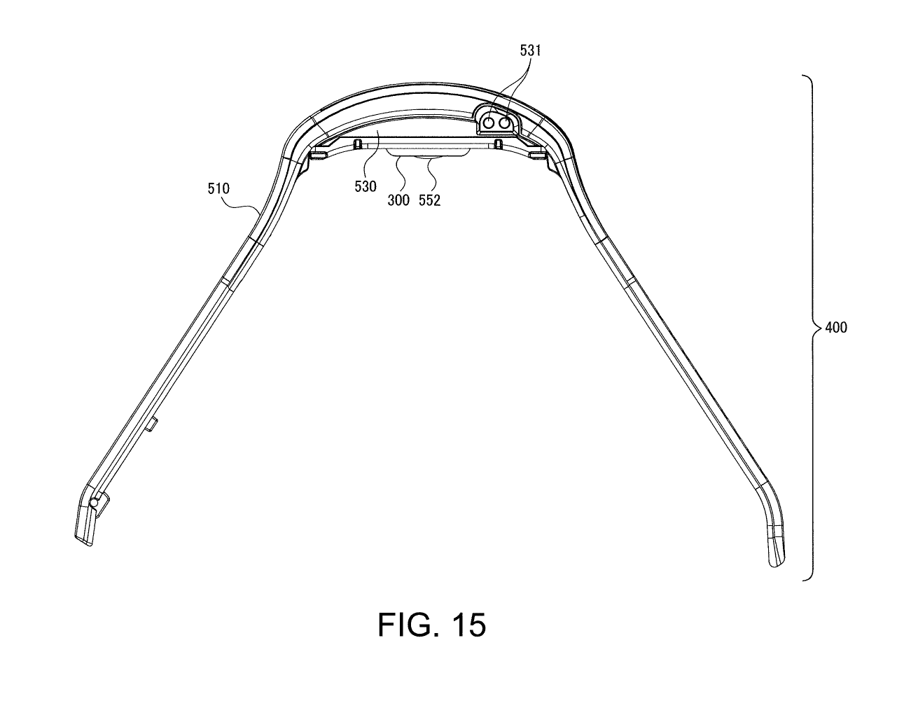

FIGS. 14A, 14B and 15 show the appearance of the biological information processing device (biological information detection device) 400 according to this embodiment. FIG. 14A shows the biological information processing device 400, as viewed from the front. FIG. 14B shows the same, as viewed from the top. FIG. 15 shows the same, as viewed from the lateral side.

As shown in FIGS. 14A to 15, the biological information processing device 400 according to the embodiment includes a band 510, a case 530, and a sensor 300. The case 530 is attached to the band 510. The sensor 300 is provided in the case 530. However, the biological information processing device 400 according to the embodiment is not limited to the configuration shown in FIGS. 14A to 15 and can be implemented with various modifications such as omitting a part of the components, replacing apart of the components with another component, or adding another component.

The band 510 is to be wound around the user's wrist so as to mount the biological information processing device 400. The band 510 has holes 512 and a buckle 514. The buckle 514 has a band insertion part 515 and a protrusion 516. The user can mount the biological information processing device 400 on the wrist by inserting one end side of the band 510 into the band insertion part 515 of the buckle 514 and inserting the protrusion 516 of the buckle 514 into one of the holes 512 in the band 510. In this case, the magnitude of pressure on the sensor 300 (pressure on the wrist surface) is adjusted according to which of the holes 512 the protrusion 516 is inserted into.

The case 530 is equivalent to the main body of the biological information processing device 400. Inside the case 530, various components such as the sensor 300 and a biological information processing system 100 (including an information acquirer 110, a processor 130, and an exercise advice information outputter 150 or the like) are provided. That is, the case 530 is a casing accommodating these components.

A light emitting window 532 is provided in the case 530. The light emitting window 532 is formed of a light-transmissive member. In the case 530, a light emitter (LED) mounted on a flexible substrate is provided, and light from this light emitter is cast outside of the case 530 via the light emitting window 532.

As shown in FIG. 15, terminals 531 are provided on the case 530. When the biological information processing device 400 is installed in a cradle, not shown, terminals of the cradle and the terminals 531 of the case 530 are electrically connected together. Thus, a secondary battery provided in the case 530 can be recharged.

A part or the majority of the processing in the biological information processing system, the server system, and the biological information processing device or the like according to the embodiments may be implemented by a program. In this case, the biological information processing system, the server system and the biological information processing device or the like according to the embodiments are implemented by a processor such as CPU executing the program. Specifically, the program stored in a non-temporary information storage device is read out, and the processor such as CPU executes the read-out program. Here, the information storage device (computer-readable device) stores a program, data and the like, and its functions can be implemented by an optical disc (DVD, CD or the like), HDD (hard disk drive) or memory (card-type memory, ROM or the like), or the like. The processor such as CPU performs the various kinds of processing according to the embodiments on the basis of the program (data) stored in the information storage device. That is, in the information storage device, a program for causing a computer (device having an operator, a processor, a storage and an outputter) to function as each part of the embodiments (program for causing a computer to execute processing of each part) is stored.

The biological information processing system, the server system and the biological information processing device or the like according to the embodiments may include a processor and a memory. The processor in this case may be, for example, a CPU (central processing unit). However, the processor is not limited to a CPU, and various other processors such as GPU (graphics processing unit) or DSP (digital signal processor) can also be used. The processor may also be a hardware circuit based on ASIC (application specific integrated circuit). The memory is for storing a computer-readable command, and as the command is executed by the processor, each part of the biological information processing system, the server system and the biological information processing device or the like according to the embodiments is implemented. The memory in this case may be a semiconductor memory such as SRAM (static random access memory) or DRAM (dynamic random access memory), or may be a register, hard disk or the like. The command in this case may be a command of a command set constituting a program, or may be a command designating an operation to the hardware circuit of the processor.

While the embodiments have been described in detail, those skilled in the art will be able to readily understand that a number of modifications can be made without substantially departing from the new matters and advantageous effects of the invention. Therefore, all such modifications are included in the scope of the invention. For example, a term described along with a different term having a broader meaning or the same meaning at least once in the description or drawings can be replaced with the different term at any point in the description or drawings. Also, the configurations and operations of the biological information processing system, the server system and the biological information processing device are not limited to those described in the embodiments and can be implemented with various modifications.

What is claimed is:

1. A biological information processing system comprising:
an information acquirer which acquires biological information and motion information of a subject measured by a sensor;
a processor which performs processing of estimating psychological state information of the subject, at least on the basis of the biological information; and
an exercise advice information outputter which outputs exercise advice information to the subject, at least on the basis of the motion information;
wherein the processor specifies an output timing when the exercise advice information is outputted, on the basis of the psychological state information, and
the exercise advice information outputter outputs the exercise advice information at the output timing that is specified.

2. The biological information processing system according to claim 1, wherein
the exercise advice information outputter outputs the exercise advice information on the basis of the motion information acquired in a predetermined period before the output timing that is specified.

3. The biological information processing system according to claim 1, wherein
the processor estimates motivation information as the psychological state information on the basis of the biological information.

4. The biological information processing system according to claim 3, wherein
the processor specifies the output timing on the basis of a timing when a motivation value expressed by the motivation information reaches a predetermined threshold or above.

5. The biological information processing system according to claim 4, wherein
the processor specifies the output timing on the basis of a timing when the motivation value reaches a predetermined threshold or above and before a timing when the motivation value reaches a maximum.

6. The biological information processing system according to claim 3, wherein
the processor
specifies a first output timing on the basis of a timing when a motivation value expressed by the motivation information reaches a first threshold or above, and
specifies a second output timing that is different from the first output timing on the basis of a timing when the motivation value becomes equal to or above a second threshold that is lower than the first threshold, and
the exercise advice information outputter
outputs first exercise advice information at the first output timing, and
outputs second exercise advice information that is different from the first exercise advice information at the second output timing.

7. The biological information processing system according to claim 6, wherein
the second exercise advice information is information with a smaller amount of information than the first exercise advice information.

8. The biological information processing system according to claim 1, wherein
the processor specifies the output timing on the basis of the psychological state information and the motion information.

9. The biological information processing system according to claim 1, wherein
there is a first exercise period to a third exercise period when the subject is in an exercising state, and a first non-exercise period and a second non-exercise period when the subject is in a non-exercising state,
if the first non-exercise period is a period between the first exercise period and the second exercise period, and
the second non-exercise period may be a period which is between the second exercise period and the third exercise period and which is longer than the first non-exercise period,
the processor specifies the second non-exercise period on the basis of the motion information and specifies a timing within the second non-exercise period as the output timing.

10. The biological information processing system according to claim 1, wherein
the processor detects an abnormal movement of the subject on the basis of the motion information and may specify the output timing on the basis of the abnormal movement that is detected.

11. The biological information processing system according to claim 1, wherein
the exercise advice information outputter generates the exercise advice information, at least on the basis of the motion information, then the processor specifies the output timing, at least on the basis of the biological information, and subsequently the exercise advice information outputter outputs the exercise advice information that is generated, at the output timing that is specified.

12. The biological information processing system according to claim 11, wherein
the processor estimates motivation information as the psychological state information and specifies the output timing on the basis of a timing when a motivation value expressed by the motivation information reaches a predetermined threshold or above.

13. The biological information processing system according to claim 11, wherein
the processor detects an abnormal movement of the subject on the basis of the motion information and specifies the exercise advice information on the basis of the abnormal movement that is detected.

14. A server system comprising the biological information processing system according to claim 1.

15. A server system comprising the biological information processing system according to claim 2.

16. A server system comprising the biological information processing system according to claim 3.

17. A biological information processing device comprising the biological information processing system according to claim 1.

18. A biological information processing device comprising the biological information processing system according to claim 2.

19. A biological information processing device comprising the biological information processing system according to claim 3.

20. A biological information processing method comprising:
acquiring biological information and motion information measured by a sensor;
performing processing of estimating psychological state information, at least on the basis of the biological information;
specifying an output timing when exercise advice information is outputted, on the basis of the psychological state information; and
outputting the exercise advice information at the output timing that is specified, at least on the basis of the motion information.
